(19) United States
(12) Patent Application Publication
(10) Pub. No.: US 2018/0100529 A1
(43) Pub. Date: Apr. 12, 2018

(54) RIVET ELEMENT AND COMPONENT ASSEMBLY COMPRISING A RIVET ELEMENT AND A SHEET METAL PART

(71) Applicant: PROFIL Verbindungstechnik GmbH & Co. KG, Friedrichsdorf (DE)

(72) Inventors: Richard Humpert, Bad Nauheim (DE); Christian Sowa, Mühlheim/Main (DE)

(21) Appl. No.: 15/730,435

(22) Filed: Oct. 11, 2017

(30) Foreign Application Priority Data
Oct. 12, 2016 (DE) 102016119478.6

(51) Int. Cl. F16B 19/10; F16B 19/05

(52) U.S. Cl. CPC F16B 19/10; F16B 19/05

(57) ABSTRACT

A rivet element having a central longitudinal direction having a head part that has a sheet metal contact surface and having a cylindrical rivet section that has features providing security against rotation is characterized in that the features providing security against rotation are formed by notches at the outer jacket surface of the cylindrical rivet section that extend in parallel with the central longitudinal direction and that extend over substantially the total length of the rivet section. A surprisingly higher security against rotation resistance is hereby achieved by the corresponding component assembly comprising a sheet metal part to which the rivet element is riveted.

The present invention relates to a rivet element and to a component assembly comprising a rivet element and a sheet metal part.

A number of rivet elements are known that have a central longitudinal direction comprising a head part having a sheet metal contact surface and that have a cylindrical rivet section having features providing security against rotation. Examples for such rivet elements and the corresponding component assemblies can be seen from EP 1 806 509 B. A number of features providing security against rotation in the form of elevated portions at the rivet sections of the elements shown are described there that all have the object of entraining the sheet metal material by a special shape of the piercing section and/or rivet section such that the folded back metal sheet is completely covered by the rivet section in the region of the rivet bead, whereby it is no longer possible that parts of the metal sheet can project out of the rivet crimp as a blade or can even be detached.

In some of the embodiments described there, the features providing security against rotation have the shape of ribs providing security against rotation that extend in the central longitudinal direction of the element and that extend at the rivet section up to the fine end of the rivet section. Embodiments of component assemblies in which the sheet metal material is folded back on itself in the region of the rivet bead are not necessarily the normal kind of component assemblies. The sheet metal part is frequently only clamped in an annular groove formed between a flange of the rivet element and the rivet bead. With most rivet elements, the features providing security against rotation are formed by noses or recesses that are located in the flange of the element or by noses or ribs located in the transition from the flange into the rivet section.

It is the object of the present invention to provide a particular kind of features providing rotation against security that surprisingly result in a considerably increased security against rotation value or security against rotation resistance that is as a rule at least 20% higher than the previously used features providing security against rotation.

Provision is made in accordance with the invention to satisfy this object that the features providing security against rotation are formed by notches at the outer jacket surface of the cylindrical rivet section that extend in parallel with the central longitudinal direction.

A security against rotation resistance is hereby typically achieved in accordance with the invention, without providing further features providing security against rotation, that is at least 20% higher than with a corresponding rivet element having conventional features providing security against rotation. Such an embodiment is also not made obvious by the known solution in accordance with the above-named EP 1 806 509 B since there only features providing security against rotation in the form of projections are addressed and it can also not be seen that an implementation of the features providing security against rotation by notches would achieve the desired effect of the metal sheet entrainment.

The notches in accordance with the invention should preferably extend over at least substantially the total length of the rivet section. This means that they should extend at least up to a rounded region of the rivet section at the free end of the rivet section, i.e. up to the typically rounded drawing edge, with somewhat shorter notches also being easily conceivable that nevertheless result in an increased security against rotation resistance.

The notches preferably have a shape that is rounded in cross-section and that in particular corresponds to a semicircular cross-section. Undesired cracks in the region of the rivet bead can largely be avoided and fatigue cracks can be counteracted by this rounded shape.

It is particularly favorable if the cylindrical rivet section has a circular, part-cylindrical surface in the regions between the notches.

Such a shape promotes the effect that is aimed for with rounded notches and is additionally relatively simple to manufacture.

Due to the security against rotation values achievable in accordance with the invention, it is not necessary to provide further features providing security against rotation at the sheet metal contact surface, which facilitates the manufacture of the rivet element and ultimately also lowers the costs of the component assembly.

If necessary, however, security against rotation recesses, in particular approximately having the form of an outwardly directed semicircular recess, can be provided at the sheet meal contact surface that are arranged around the central longitudinal axis at angular positions that are each disposed between two adjacent notches. An additional security against rotation can hereby be achieved.

There is furthermore the possibility of providing security against rotation noses at the sheet metal contact surface, in particular noses extending in a radial direction that are arranged at, i.e. aligned with, angular positions corresponding to the angular positions of the notches. The security against rotation resistance can hereby be further increased. Furthermore, the sheet metal material is deformed in a wave-like manner in the region of the noses, which also increases the security against rotation resistance, and indeed without thinning the sheet metal material to an non-permitted extent at points since the sheet metal material displaced by the noses can be received in the notches that are disposed at the same angular positions as the noses.

It is favorable if three to twelve notches are provided: less than three notches do not result in the desired security against rotation resistance and with more than twelve notches, they tend to have to be smaller, which can also have a disadvantageous effect on the security against rotation resistance.

The solution in accordance with the invention can be successfully used with rivet elements in the form of bolt elements, with the bolt elements being known bolt elements, for example of the type of an SBF element or of an SBF element having a conical sheet metal contact surface or of the type of an NBR rivet bolt that can all be obtained from Profilverbindungstechnik GmbH & Co. KG, or comparable bolt-like rivet elements of competitors.

Alternatively to this, the invention can be successfully used with rivet elements in the form of nut elements, for example with nut elements of the type of an RSF element, of an RSN element, of an RND element or of an EMP element that can all be obtained from Profilverbindungstechnik GmbH 6 Co. KG, or comparable nut elements of competitors.

A component assembly in accordance with the invention comprising a sheet metal part to which at least one rivet element in accordance with the invention is fastened is characterized in that sheet metal material contacts the sheet metal contact surface and the rivet section and is engagement with the notches.

Further preferred embodiments of the component assemblies in accordance with the invention can be seen from the dependent claims and from the following description of embodiments or of the drawing.

There are shown in the drawing:

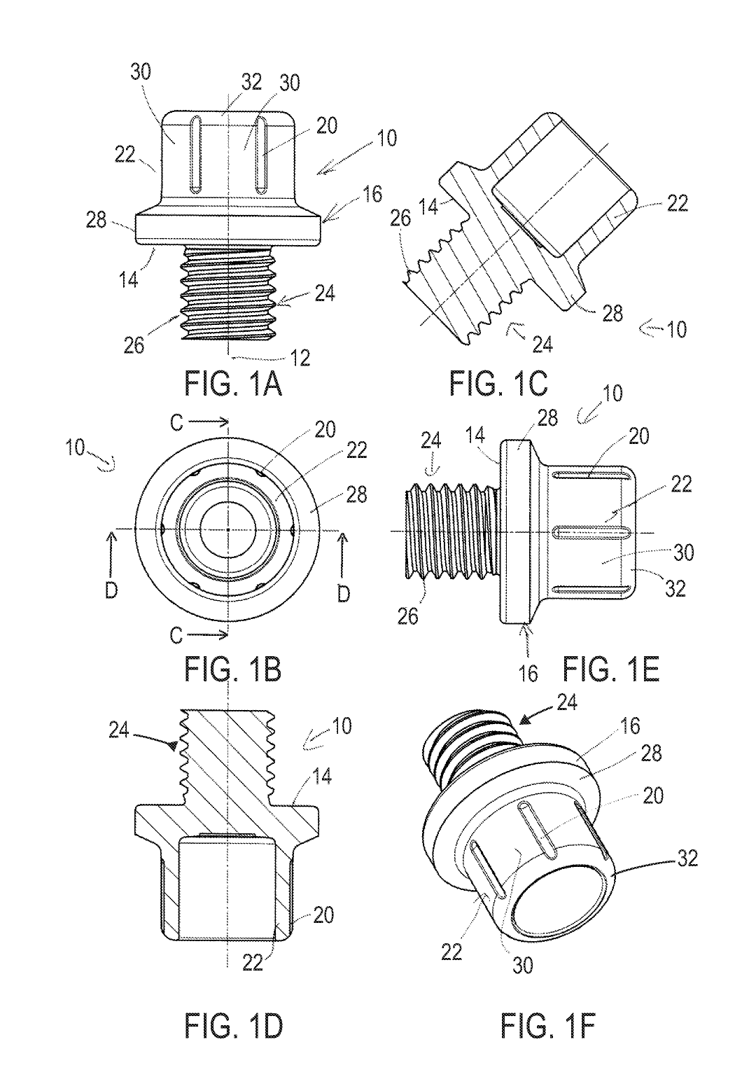

FIGS. 1A-1F representations of a modified SBF bolt element in accordance with the invention of Profil Verbindungstechnik GmbH & Co. KG, and indeed in FIG. 1A in a side view approximately in the direction of the arrow D in FIG. 1B,
in FIG. 1B in a front view of Fig. A viewed from above;
in FIG. 1C in a sectional drawing corresponding to the sectional plane C-C of FIG. 1B,
in FIG. 1D in a sectional drawing corresponding to the sectional plane D-D of FIG. 1B,
in FIG. 1E in a side view approximately in the direction of the arrow C of FIG. 1B, and
in FIG. 1F in a perspective representation;

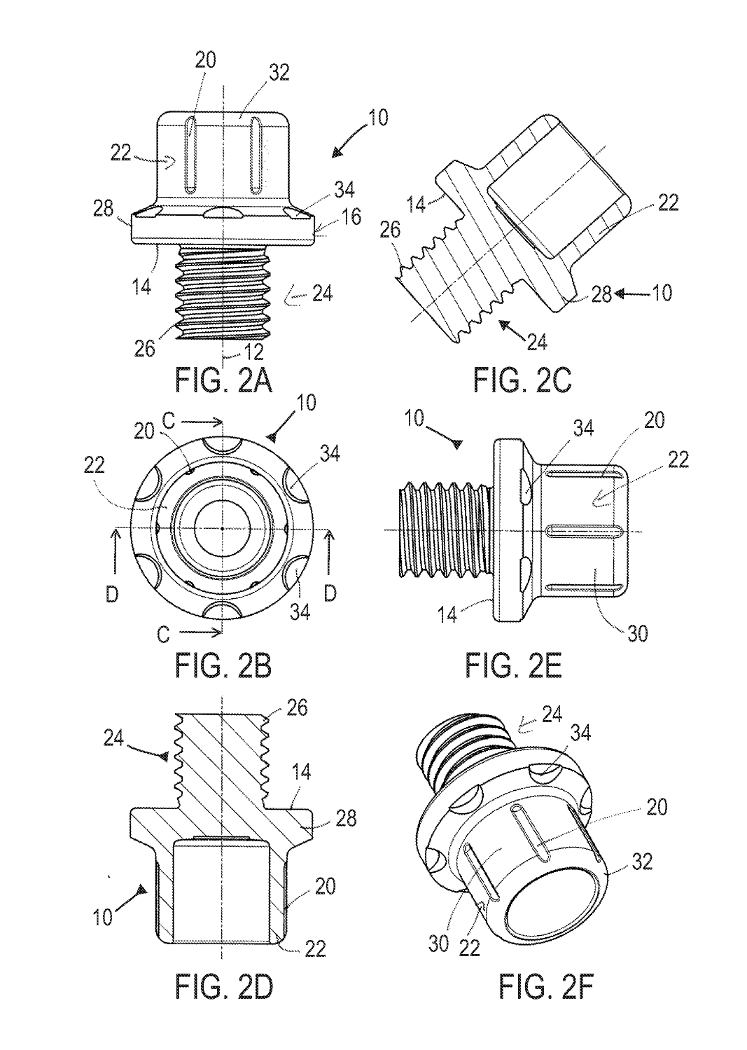

FIGS. 2A-2F representations in accordance with FIGS. 1A to 1F, but of an embodiment having additional features providing security against rotation in the region of the flange, here in the form of recesses;

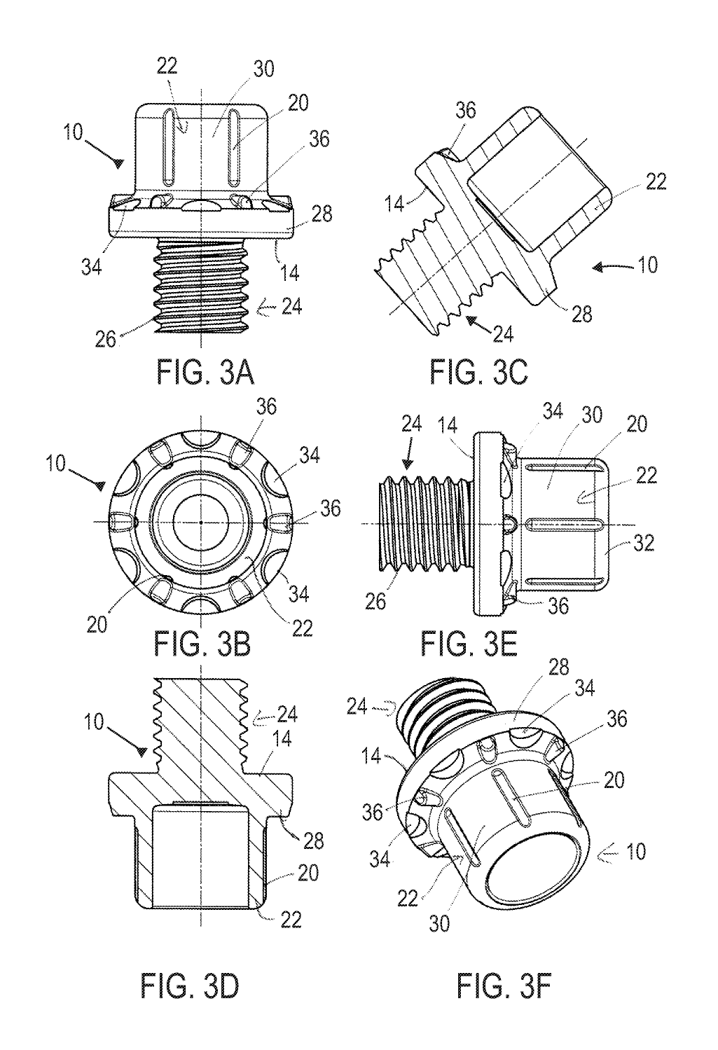

FIGS. 3A-3F representations in accordance with FIGS. 1A to 1F, but of an embodiment having additional features providing security against rotation in the region of the flange, here in the form of alternating recesses and noses, with the noses being provided at points angle-wise that are aligned with the notches at the rivet section and with the recesses being respectively arranged between two notches at the rivet section;

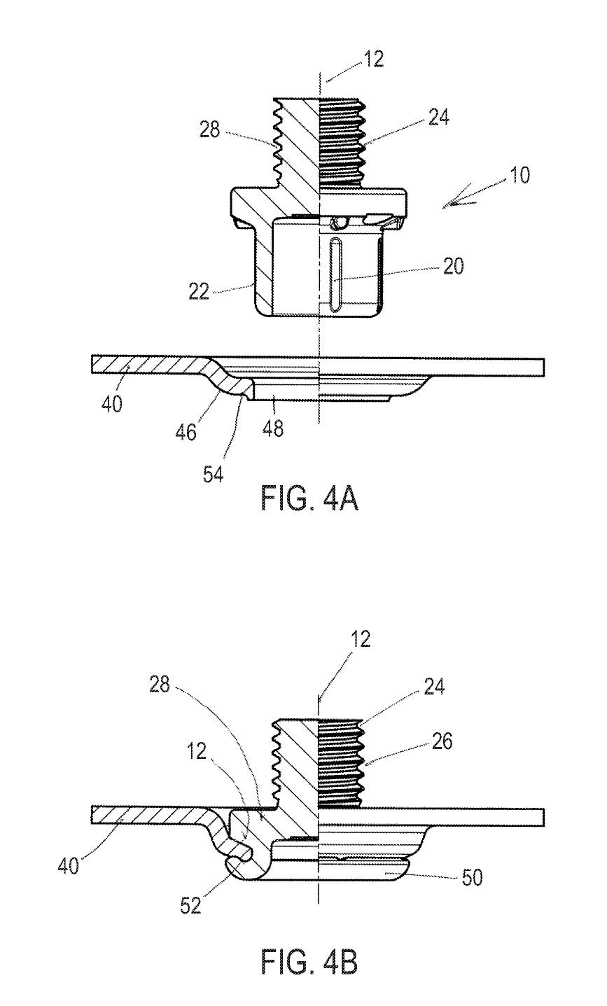

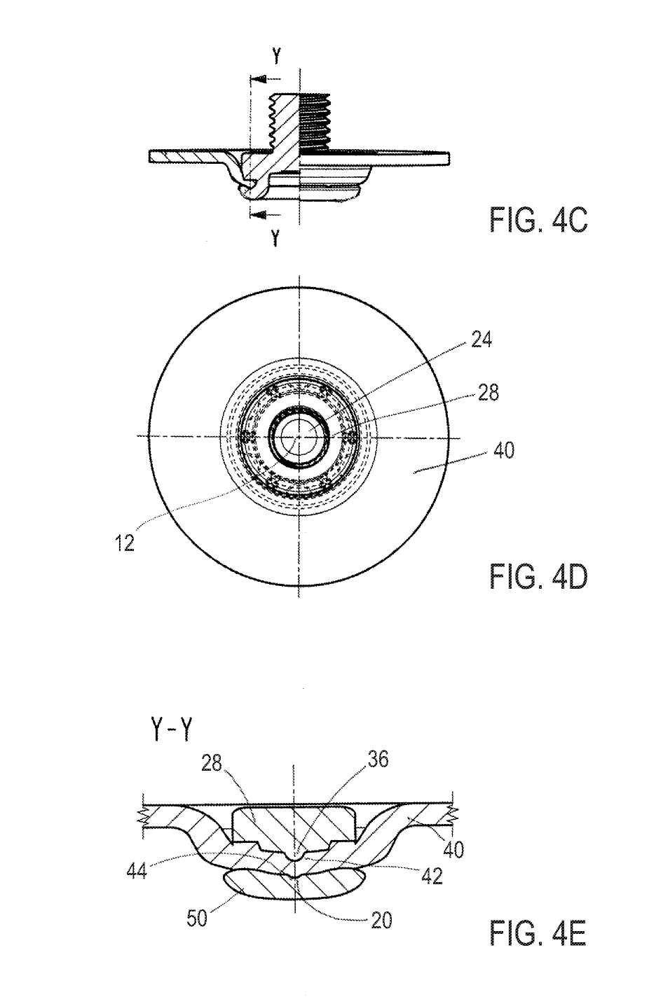

FIGS. 4A-4E a series of drawings to explain the attachment of the rivet element in accordance with FIGS. 3A-3F to a sheet metal part, with FIG. 4A showing the starting position with the element above a pre-pierced sheet metal part provided with a crimp; FIG. 4B showing a partly sectional view of the component assembly that arises on the riveting of the rivet element to the sheet metal part; FIG. 4C showing the same drawing as FIG. 4B, but with a representation of the sectional plane Y-Y and at a smaller scale; FIG. 4D showing a front view of the component assembly of FIGS. 4B and 4C, and FIG. 4E showing an enlarged representation in accordance with the sectional plane Y-Y of FIG. 4C;

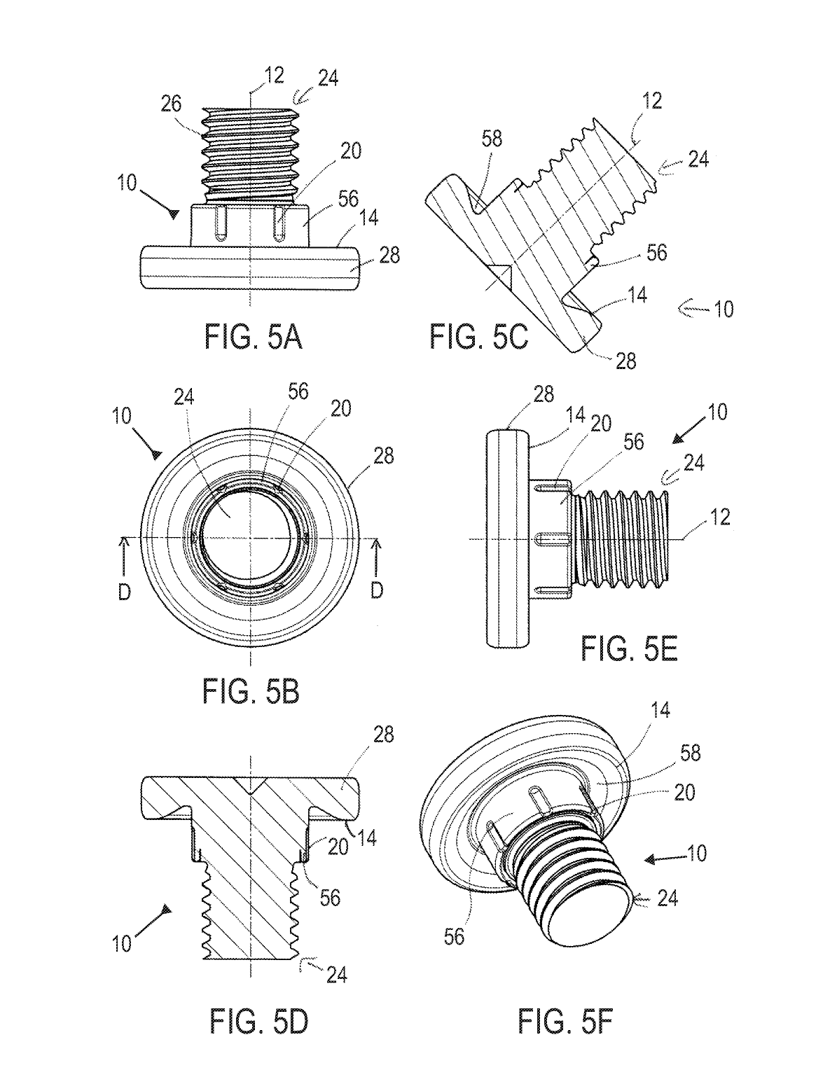

FIGS. 5A-5F representations of an NBR bolt modified in accordance with the invention of Profil Verbindungstechnik GmbH & Co. KG, with the views being made in accordance with the drawings of FIGS. 1A to 1F;

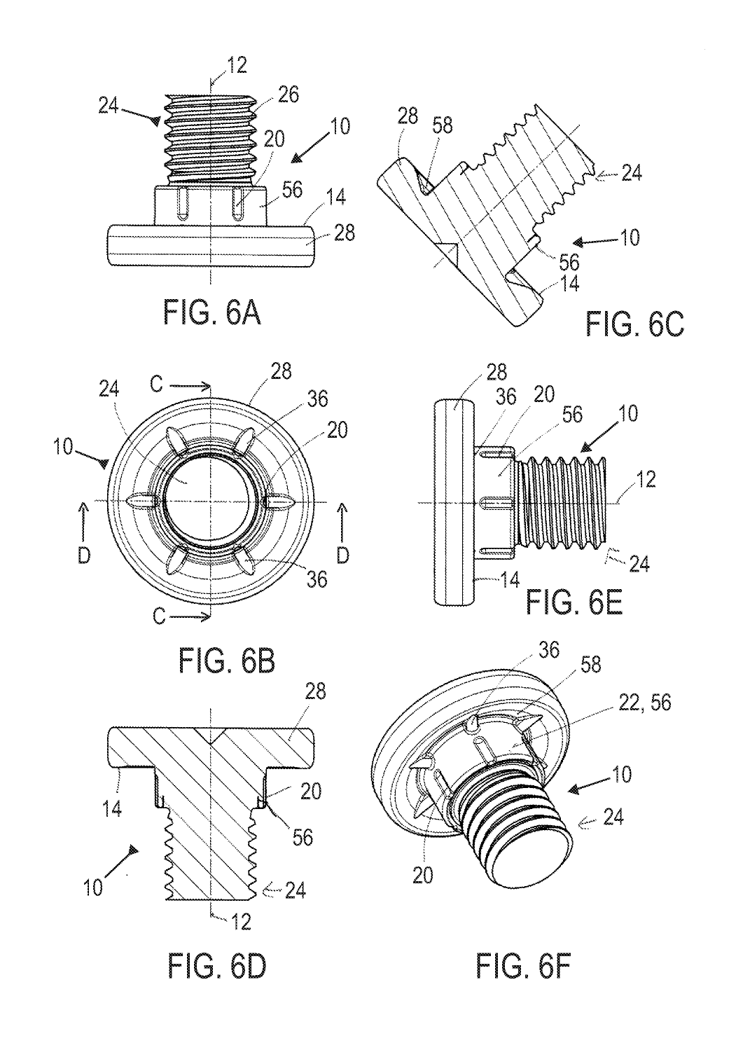

FIGS. 6A-6F representations in accordance with FIGS. 5A to 5F, but of an embodiment having additional features providing security against rotation in the region of the flange, here in the form of noses that are provided at points angle-wise that are aligned with the notches at the rivet section;

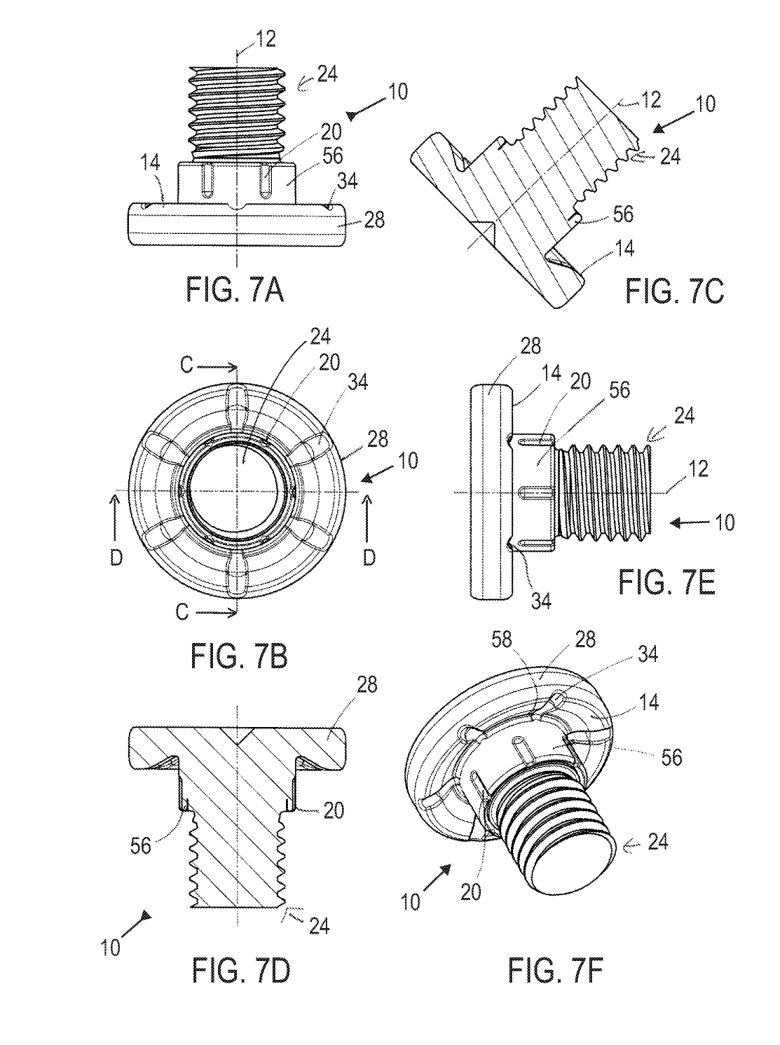

FIGS. 7A-7F representations in accordance with FIGS. 5A to 5F, but of an embodiment having additional features providing security against rotation in the region of the flange, here in the form of recesses that are respectively arranged between two notches at the rivet section;

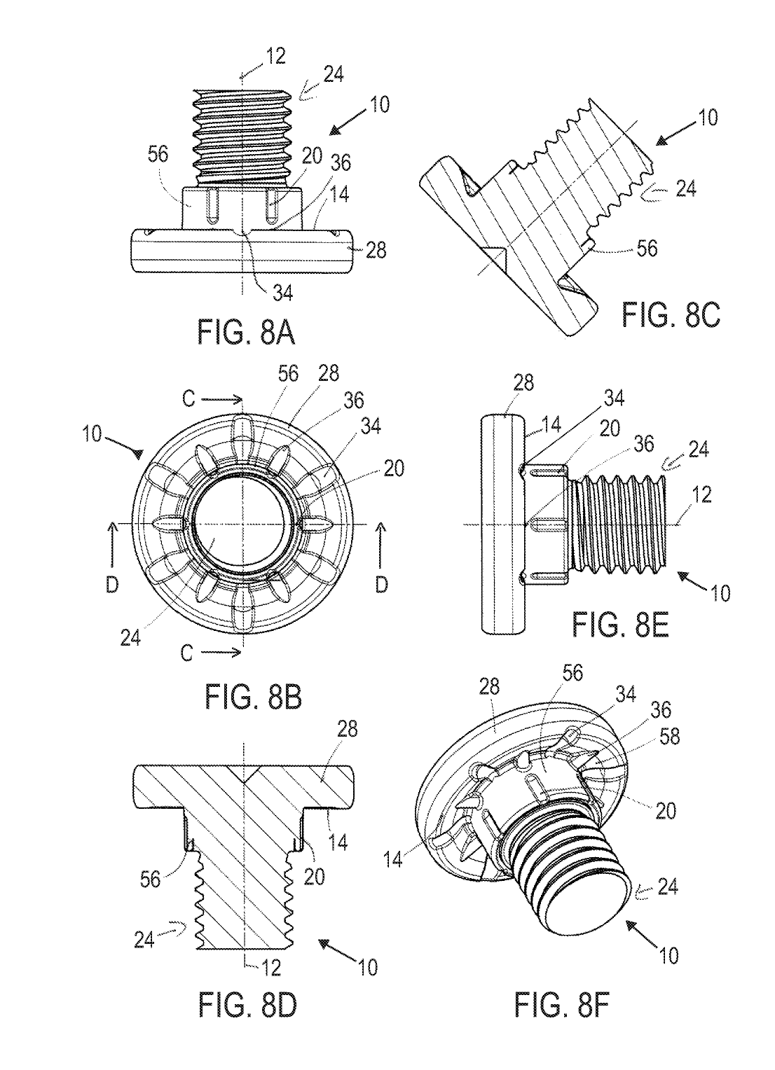

FIGS. 8A-8F representations in accordance with FIGS. 5A to 5F, but of an embodiment having additional features providing security against rotation in the region of the flange, here in the form of alternating recesses and noses, with the noses being provided at points angle-wise that are aligned with the notches at the rivet section and with the recesses being respectively arranged between two notches at the rivet section;

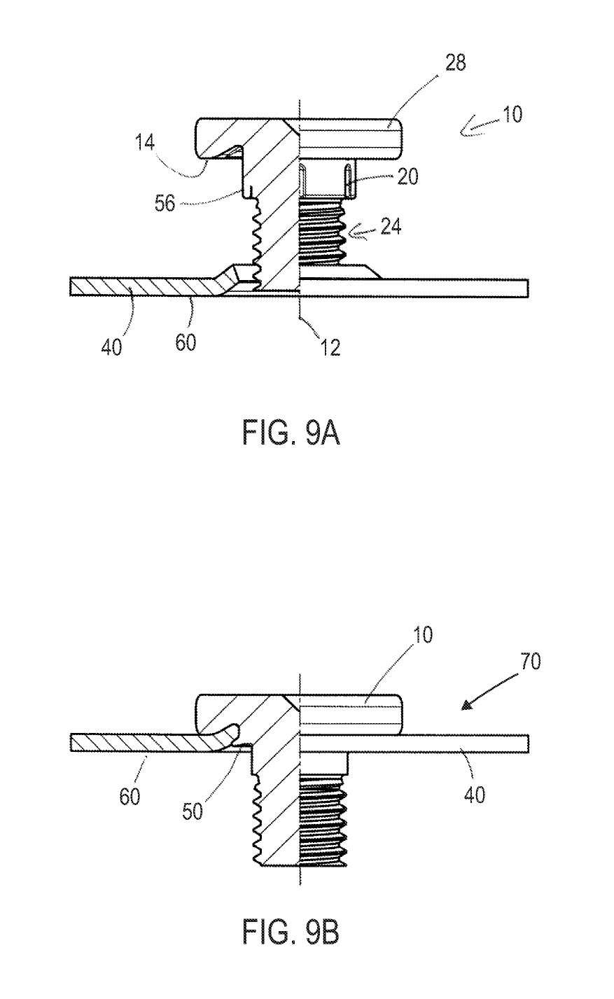

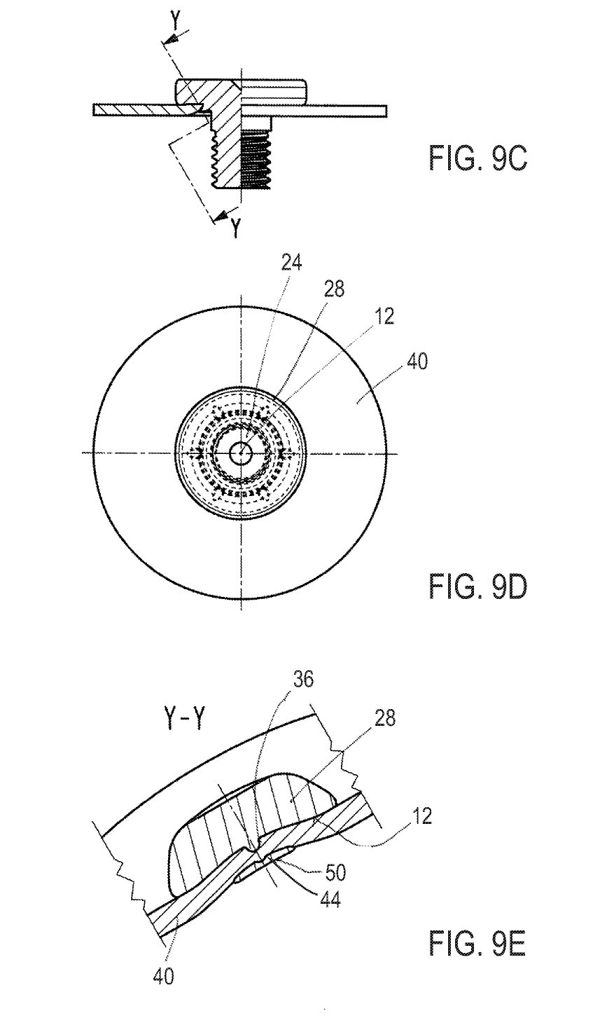

FIGS. 9A-9E a series of drawings to explain the attachment of the rivet element in accordance with FIGS. 6A-6F to a sheet metal part, with the views being made in accordance with the drawing of FIGS. 1A to 1F:

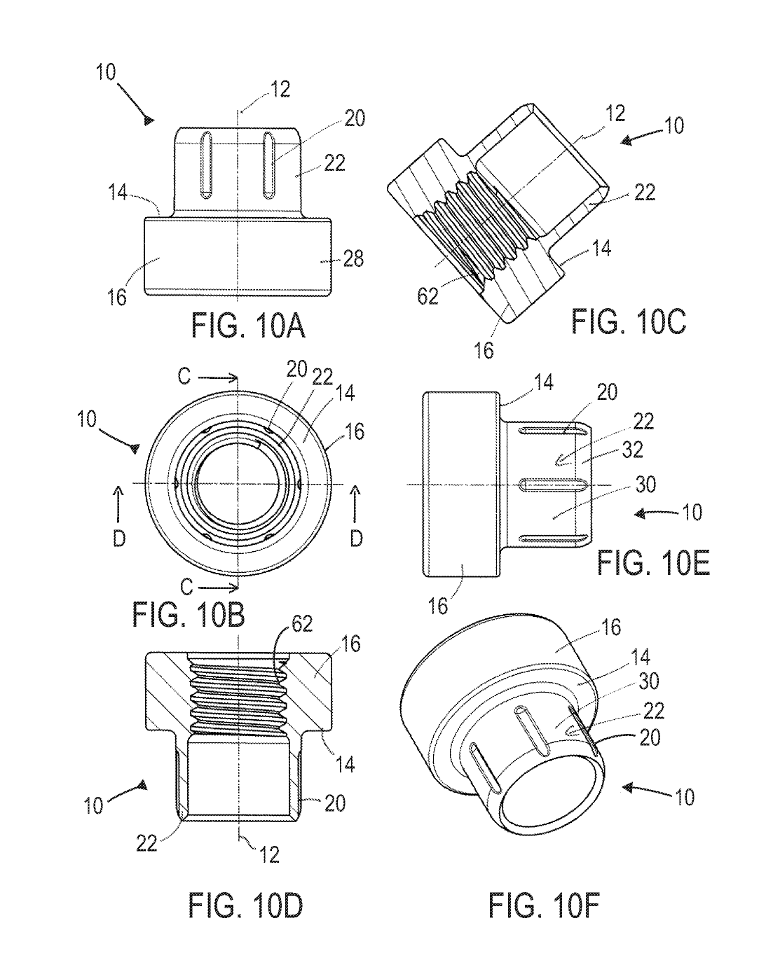

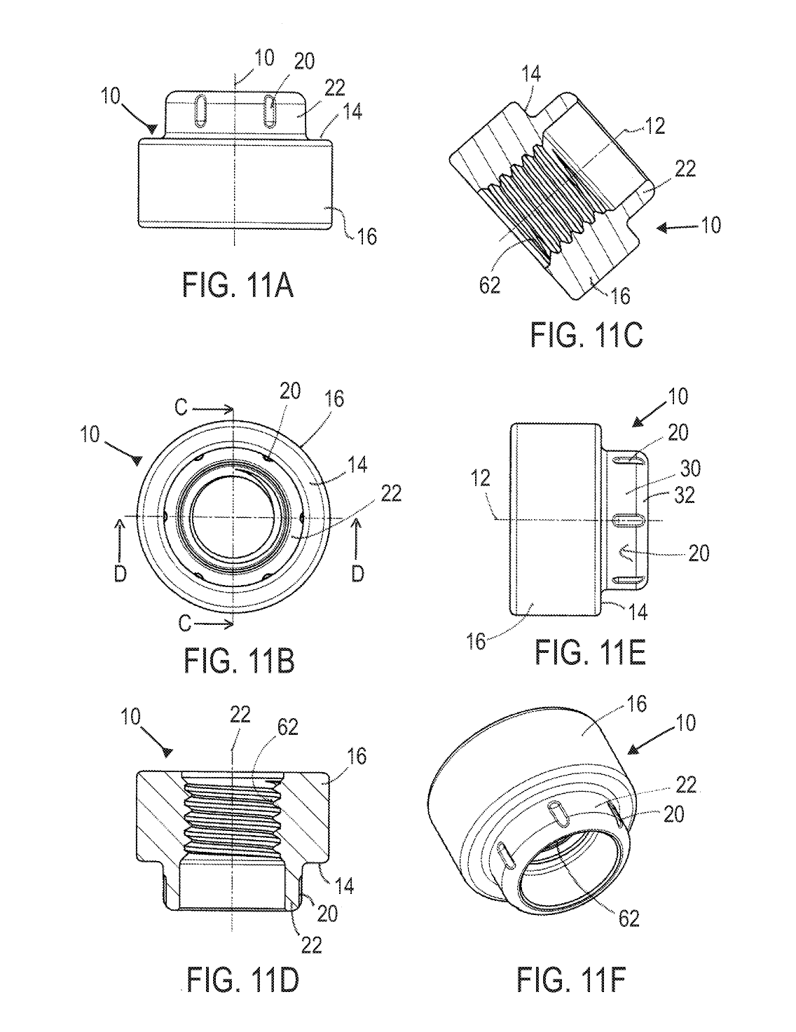

FIGS. 10A-10F representations of an RSF rivet nut modified in accordance with the invention of Profil Verbindungstechnik GmbH & Co. KG, with the views being made in accordance with the drawings of FIGS. 1A to 1F;

FIGS. 11A-11F representations of an RSN rivet nut modified in accordance with the invention of Profil Verbindungstechnik GmbH & Co. KG that is very similar to the RSF rivet nut, with the views being made in accordance with the drawings of FIGS. 1A to 1F;

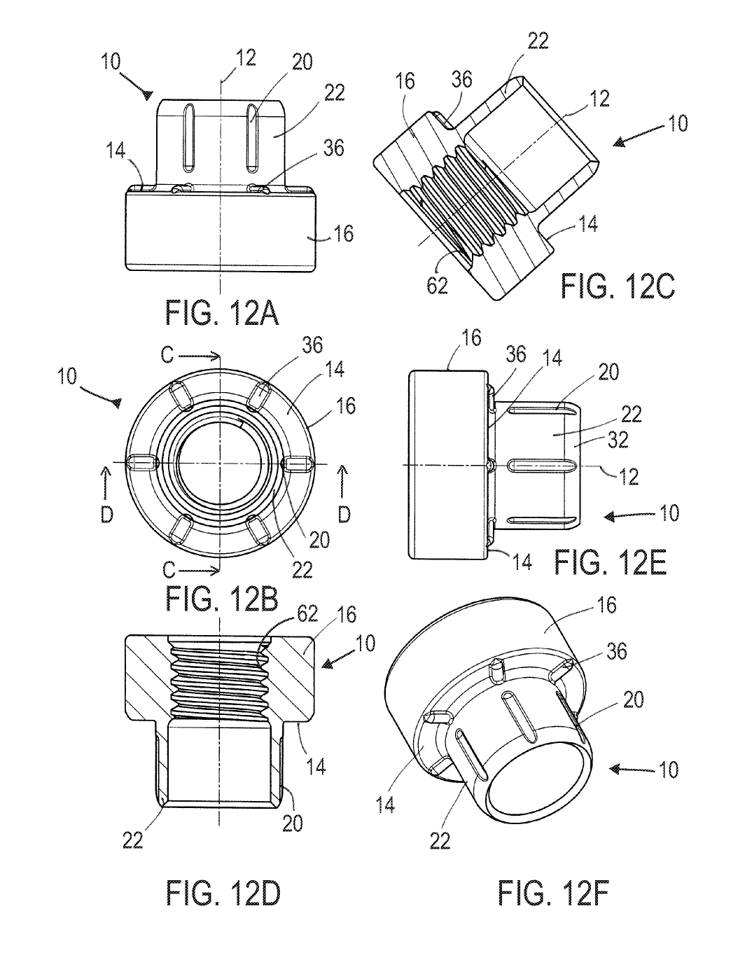

FIGS. 12A-12F representations in accordance with FIGS. 10A to 10F, but of an embodiment having additional features providing security against rotation in the region of the flange, here in the form of noses that are provided at points angle-wise that are aligned with the notches at the rivet section;

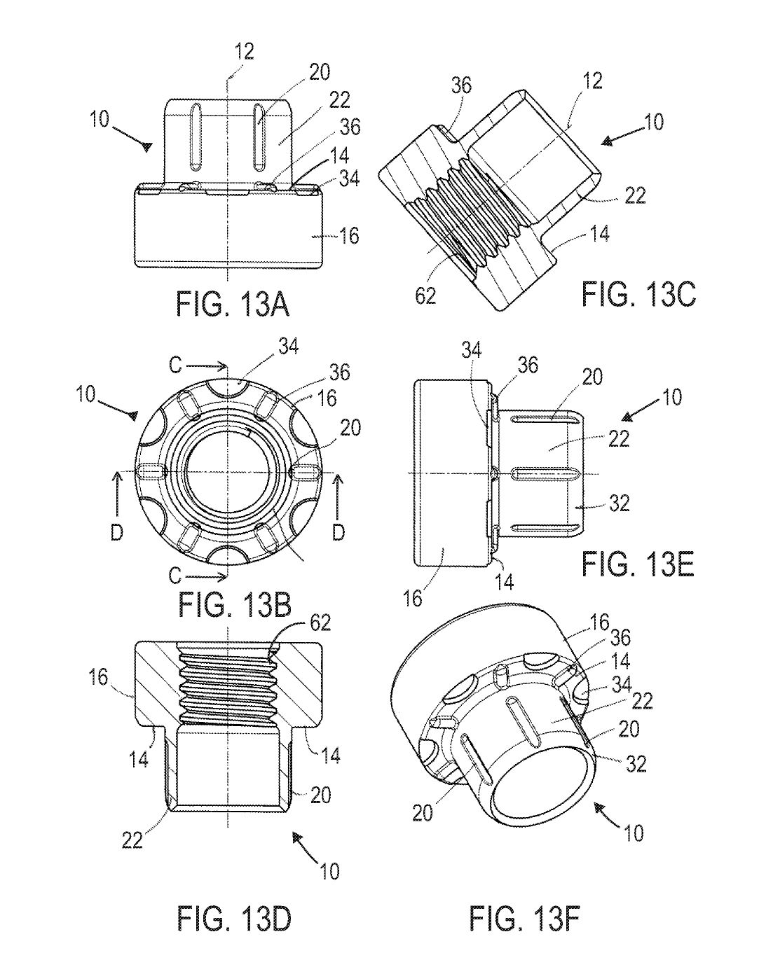

FIGS. 13A-13F representations in accordance with FIGS. 10A to 10F, but of an embodiment having additional features providing security against rotation in the region of the flange, here in the form of alternating recesses and noses, with the noses being provided at points angle-wise that are aligned with the notches at the rivet section and with the recesses being respectively arranged between two notches at the rivet section;

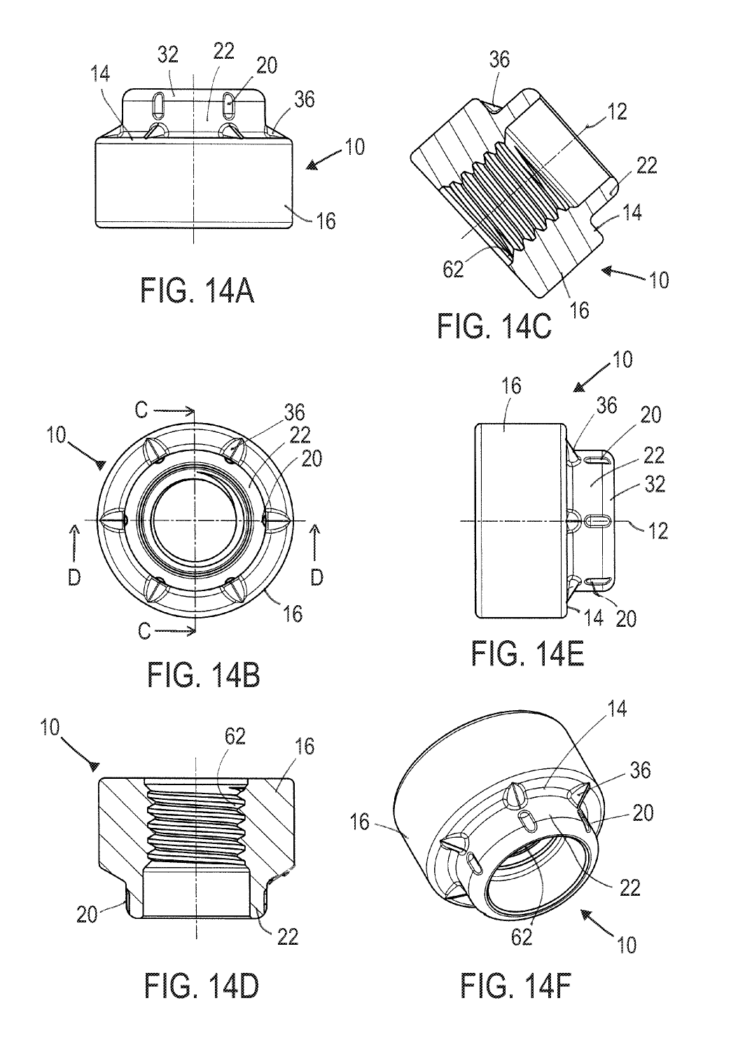

FIGS. 14A-14F representations in accordance with FIGS. 11A to 11F, but of an embodiment having additional features providing security against rotation in the region of the flange, here in the form of noses that are provided at points angle-wise that are aligned with the notches at the rivet section;

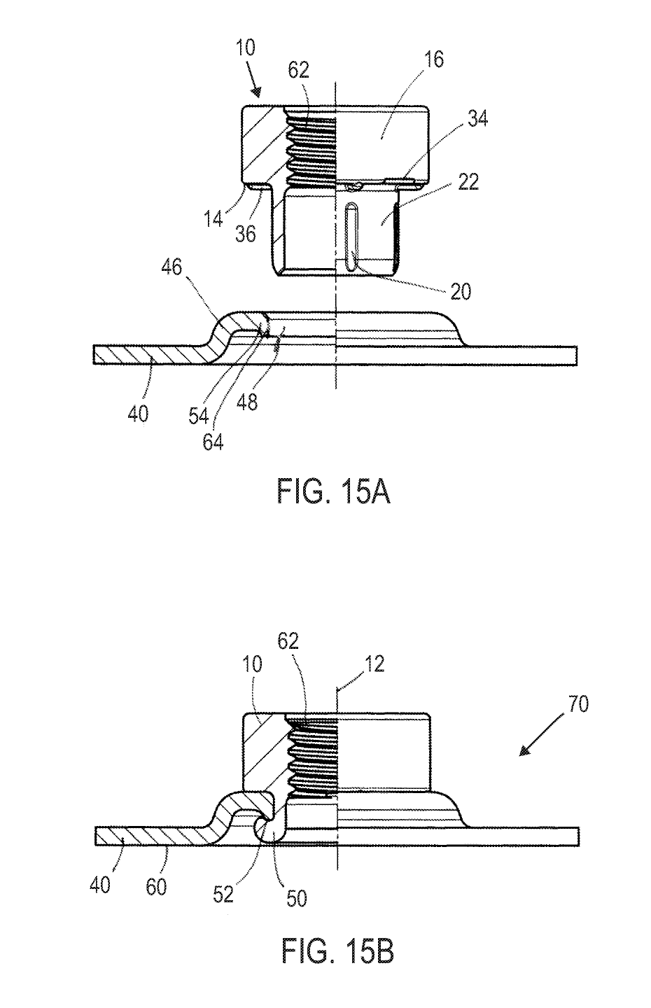

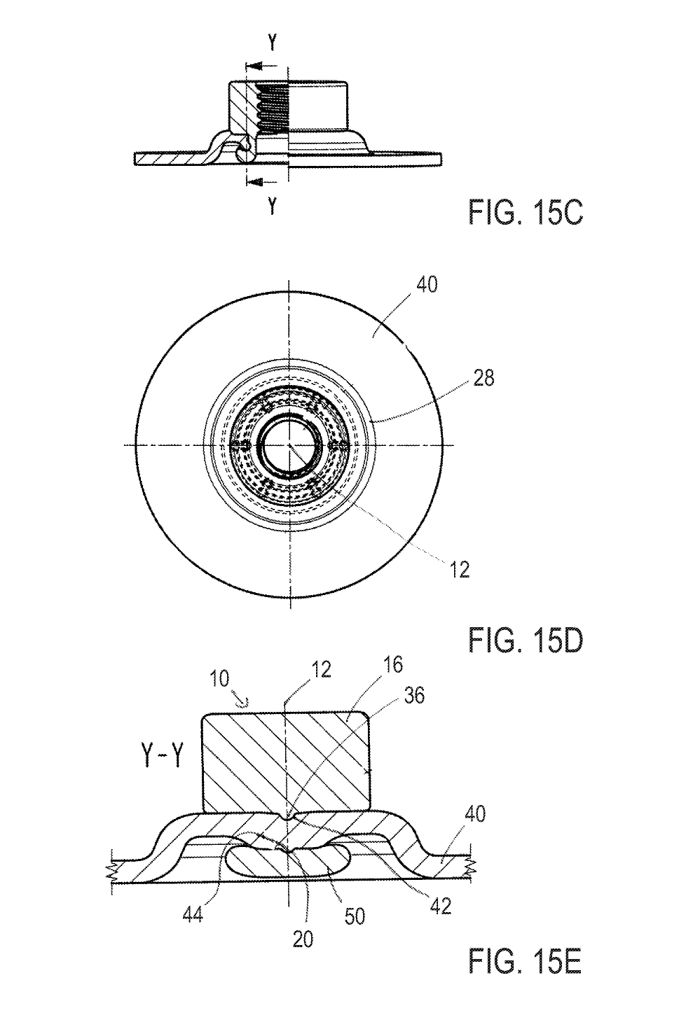

FIGS. 15A-15E a series of drawings to explain the attachment of the rivet element similar to an RSF rivet element in accordance with FIGS. 13A-13F to a sheet metal part, with the views being made in accordance with FIGS. 1A to 1F:

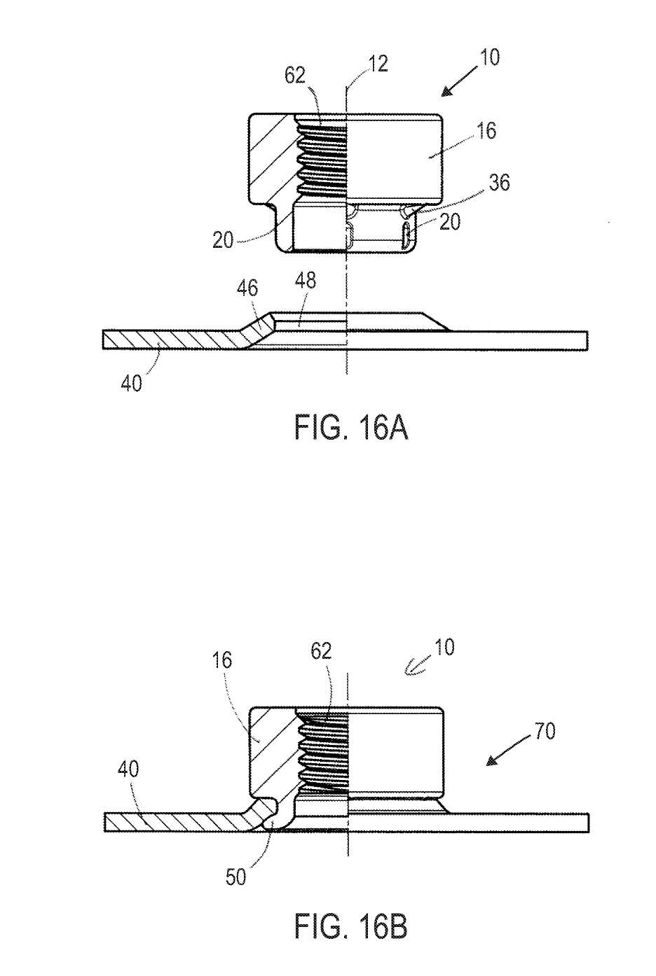

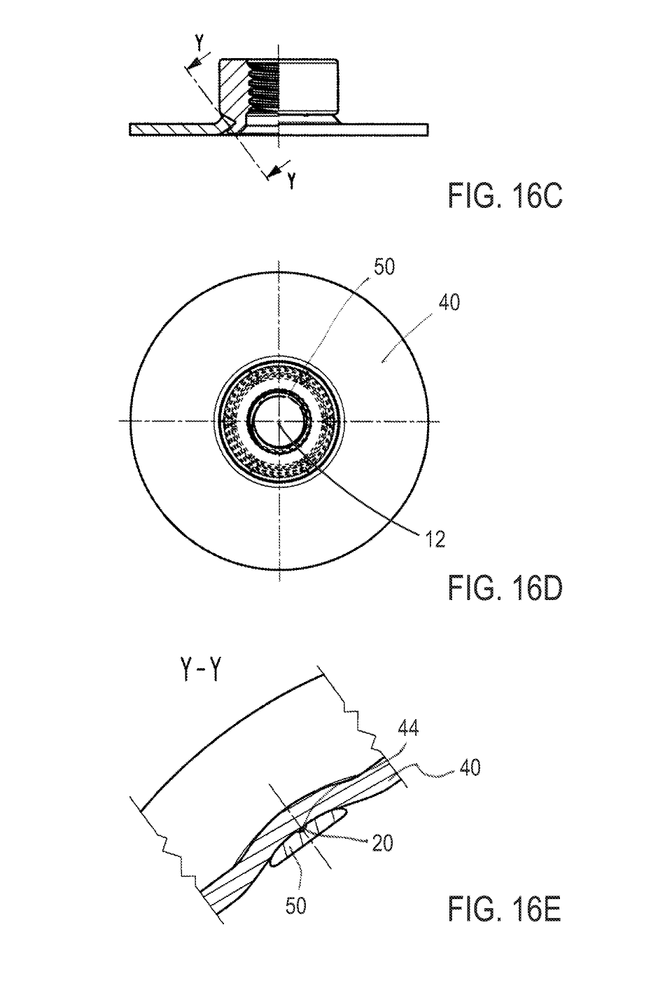

FIGS. 16A-16E a series of drawings to explain the attachment of the rivet element similar to an RSN rivet element in accordance with FIGS. 14A-14F to a sheet metal part, with the views being made in accordance with FIGS. 1A to 1F:

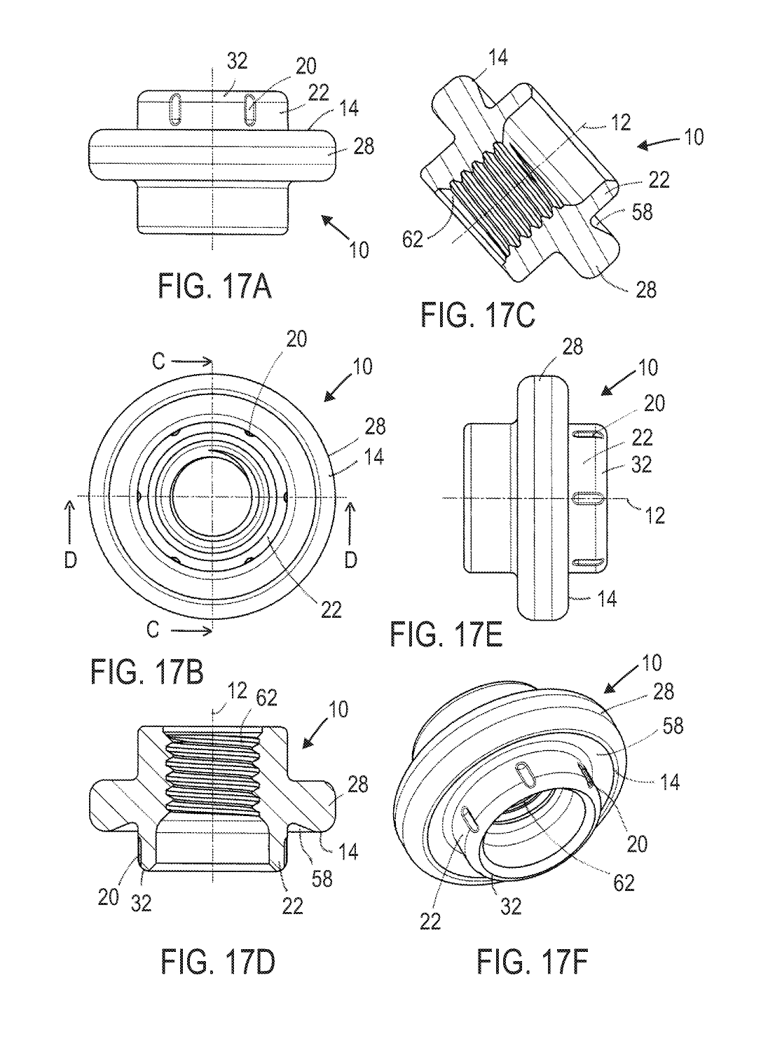

FIGS. 17A-17F representations of an RND rivet nut modified in accordance with the invention of Profil Verbindungstechnik GmbH & Co. KG, with the views being made in accordance with the drawings of FIGS. 1A to 1F, and with the bars providing security against rotation that bridge the annular groove at the lower side of the flange with an RDN rivet nut being omitted;

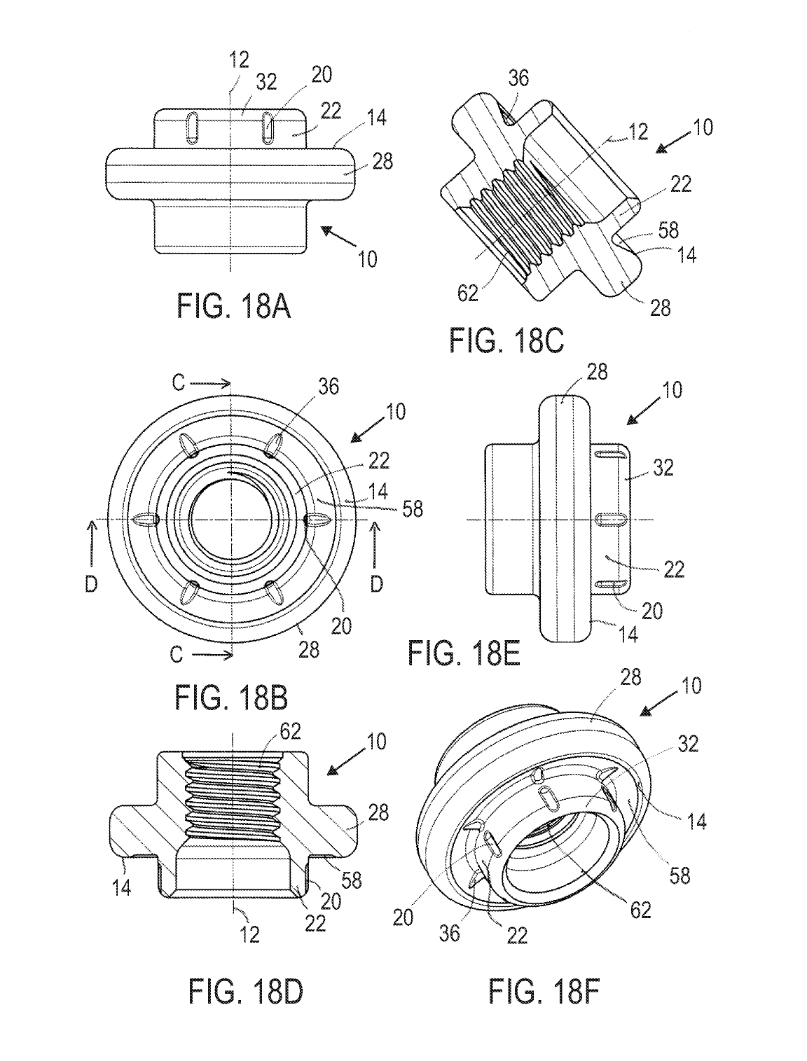

FIGS. 18A-18F representations of an RND rivet nut modified in accordance with the invention of Profil Verbindungstechnik GmbH & Co. KG, with the views being made in accordance with the drawings of FIGS. 1A to 1F, with the bars providing security against rotation that bridge the annular groove at the lower side of the flange with an RDN rivet nut being retained here and being aligned angle-wise with the notches at the rivet section;

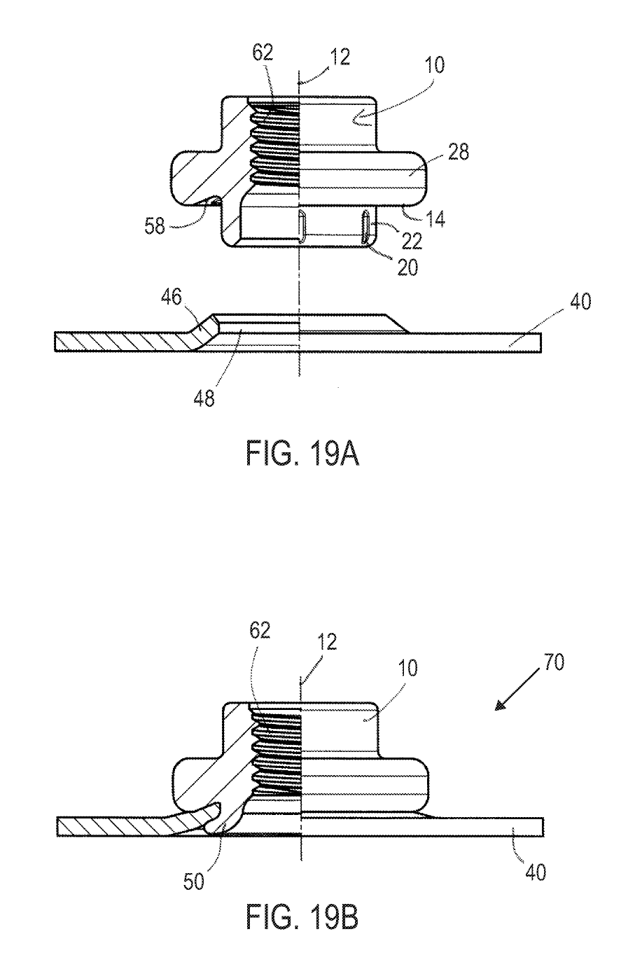

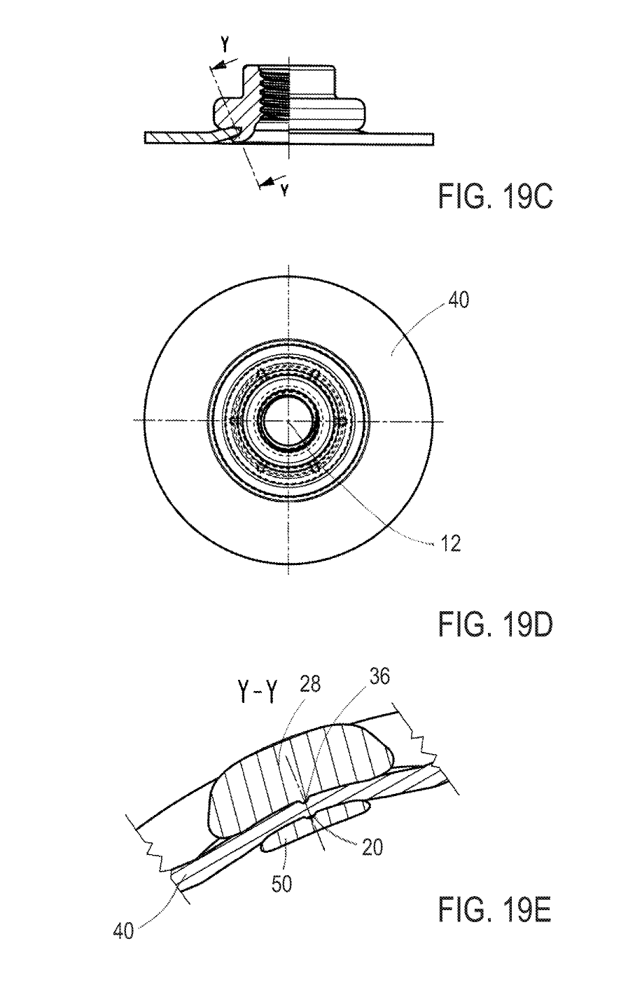

FIGS. 19A-19E a series of drawings to explain the attachment of the rivet element similar to an RND rivet element in accordance with FIGS. 18A-18F to a sheet metal part, with the views being made in accordance with FIGS. 1A to 1F:

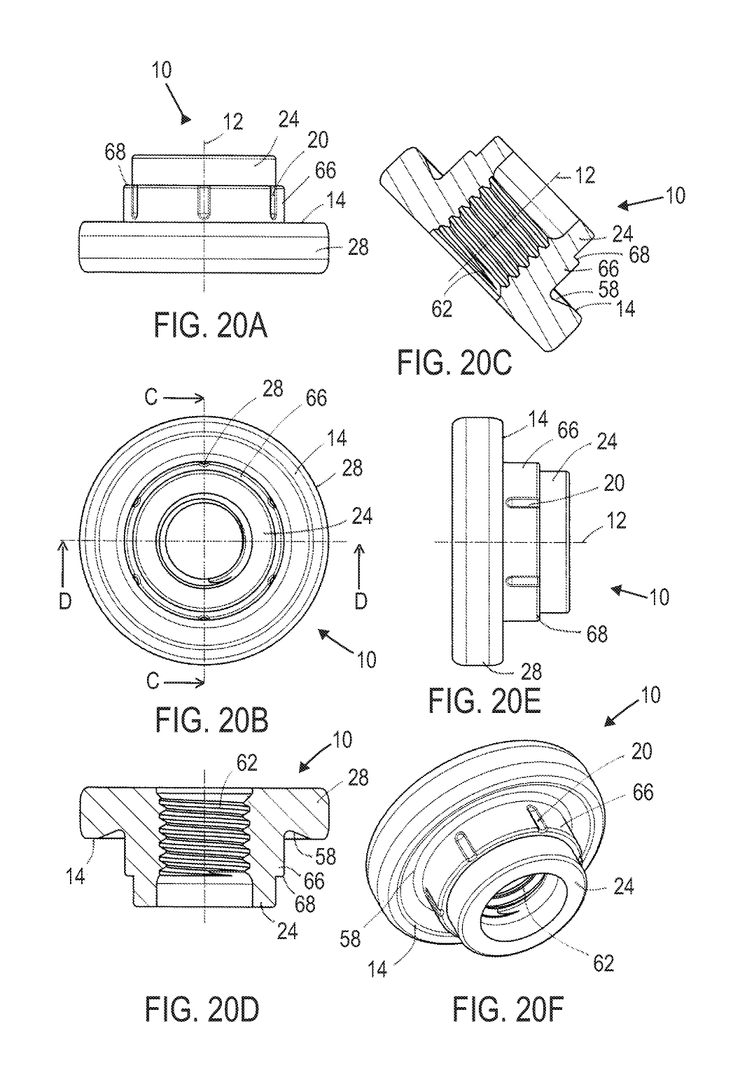

FIGS. 20A-20F representations of an EMF rivet nut modified in accordance with the invention of Profil Verbindungstechnik GmbH & Co. KG, with the views being made in accordance with the drawings of FIGS. 1A to 1F, and with the bars providing security against rotation that bridge the annular groove at the lower side of the flange with an RDN rivet nut being omitted;

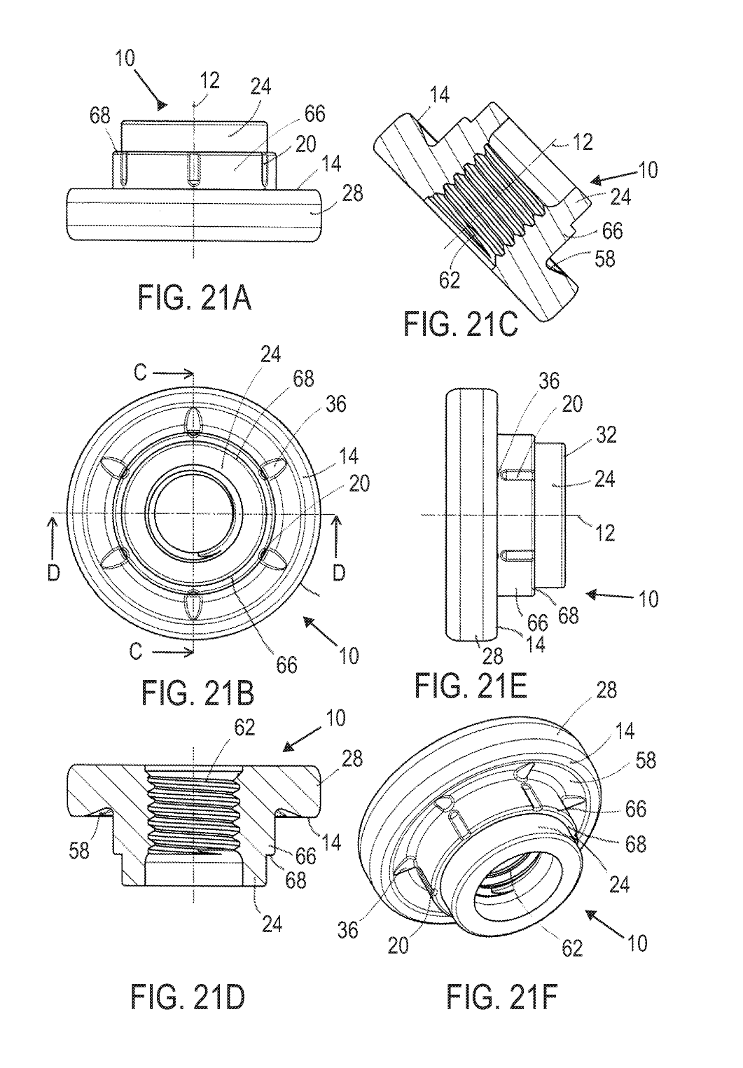

FIGS. 21A-21F representations of an EMF rivet nut modified in accordance with the invention of Profil Verbindungstechnik GmbH & Co. KG, with the views being made in accordance with the drawings of FIGS. 1A to 1F, with the bars providing security side of the flange with an EMF rivet nut being retained here and being aligned angle-wise with the notches at the rivet section;

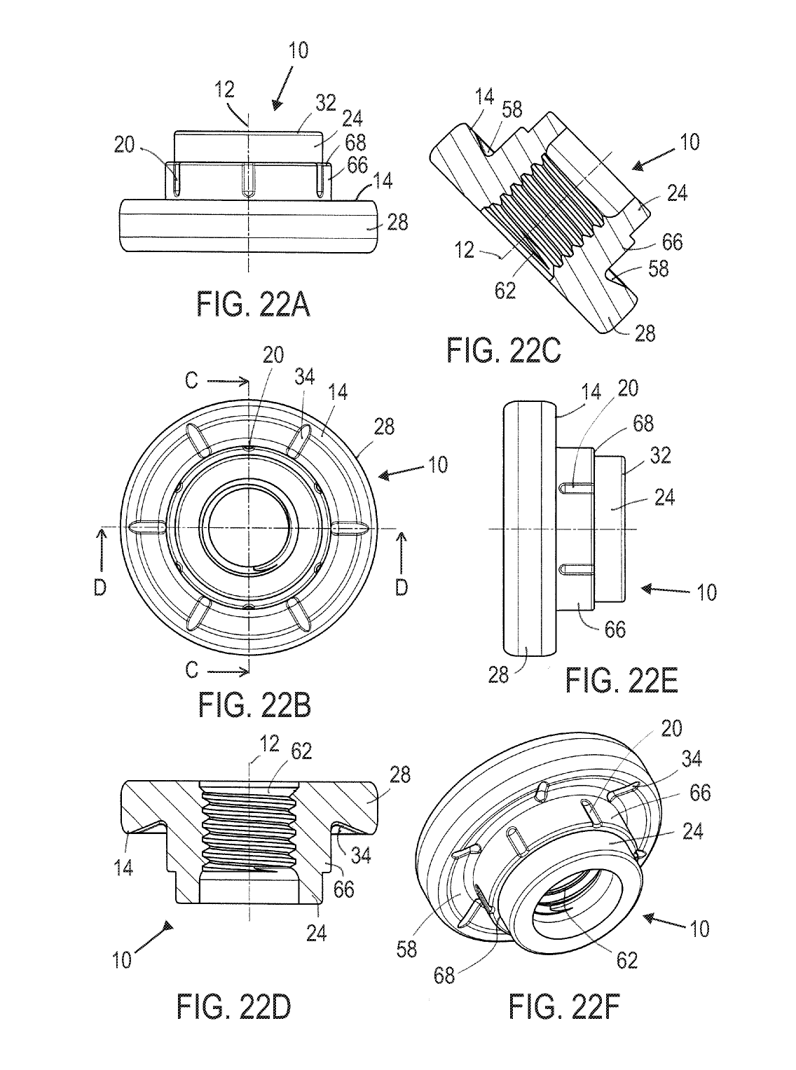

FIGS. 22A-22F representations of a still further EMF rivet nut modified in accordance with the invention of Profil Verbindungstechnik GmbH & Co. KG, with the views being made in accordance with the drawings of FIGS. 1A to 1F, with the bars providing security against rotation that bridge the annular groove at the lower side of the flange with an EMF rivet nut being omitted here, and with instead grooves or recesses extending in a radial direction being provided in the side of the annular groove at the lower side of the flange, and indeed at respective points that are disposed angle-wise between two adjacent notches;

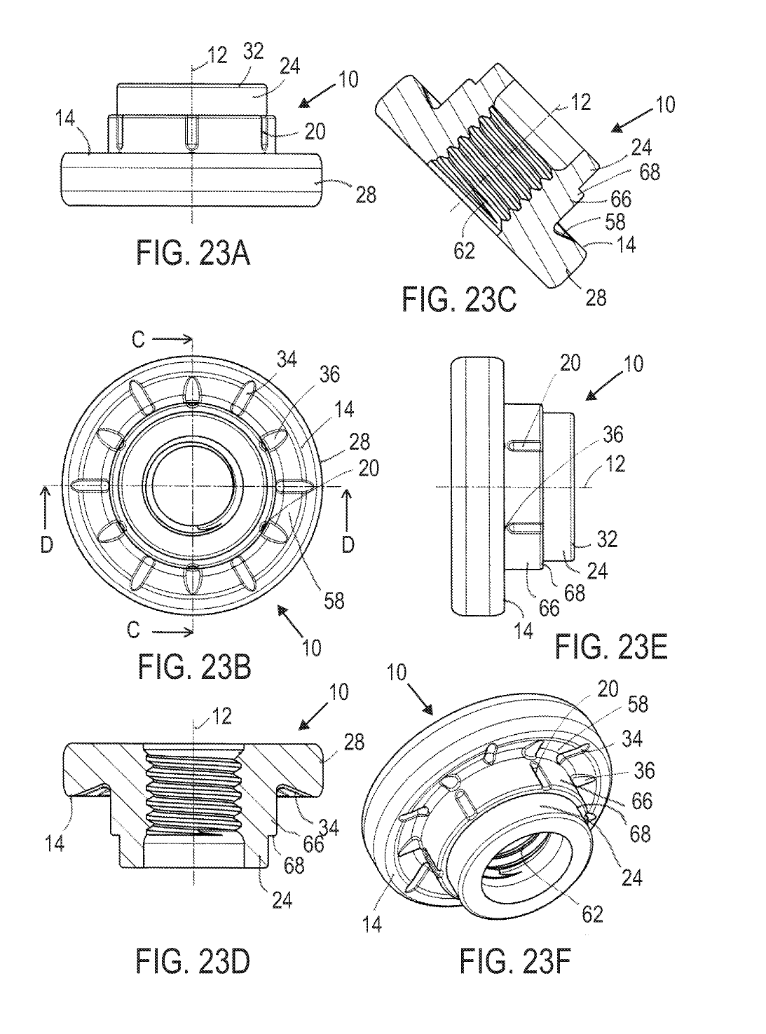

FIGS. 23A-23F representations of a still further EMF rivet nut modified in accordance with the invention of Profil Verbindungstechnik GmbH & Co. KG similar to the embodiment in accordance with FIGS. 21A to 21F, with the views being made in accordance with the drawings of FIGS. 1A to 1F, with in addition to the bars providing security against rotation that bridge the annular groove at the lower side of the flange with an EMF rivet nut, grooves or recesses extending in a radial direction being provided in the side of the annular groove at the lower side of the flange, and indeed at respective points that are disposed angle-wise between two adjacent notches; and

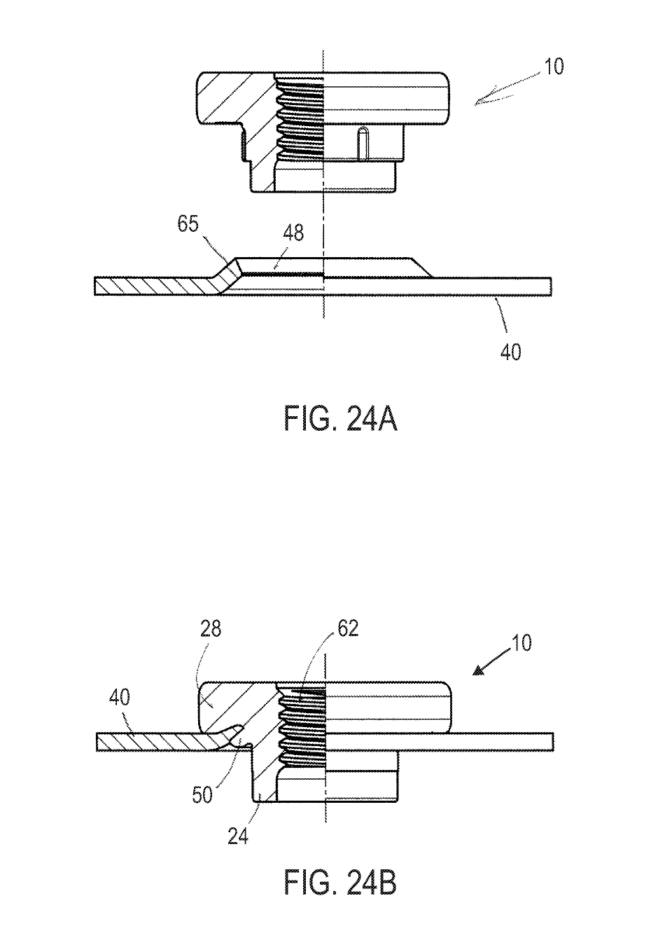

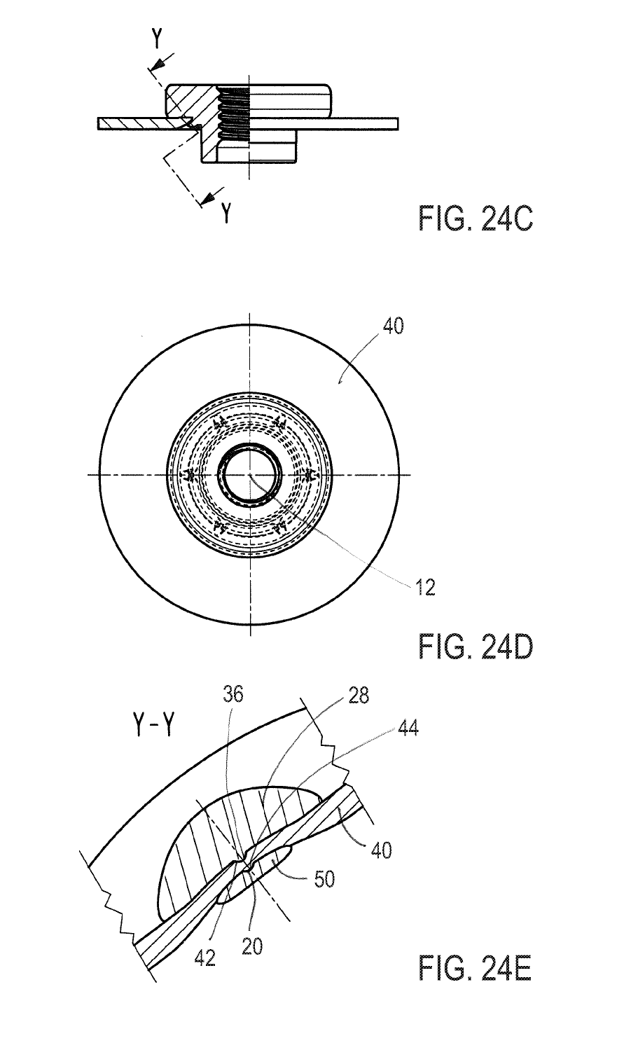

FIGS. 24A-24E a series of drawings to explain the attachment of the rivet element similar to an EMF rivet nut in accordance with FIGS. 21A-21F to a sheet metal part, with the views being made in accordance with FIGS. 1A to 1F.

In all the embodiments, the same reference numerals are used for parts that have the same shape or the same function and it is understood that the description is also to be understood accordingly for other embodiments, i.e. it applies where the same reference numerals are used.

Since the individual embodiments of the invention have a high number of common features and since the brief description of the individual Figures contains a lot of information on the individual embodiments, the embodiments in accordance with FIGS. 1 to 4 are first described in detail and subsequently the further embodiments are only described in important aspects that cannot be seen from the use of the same reference numerals or from the brief description of the Figures.

FIG. 1 shows a rivet element 10, here in the form of a bolt element, having a central longitudinal direction, having a head part 16 having a sheet metal contact surface 14, and having a cylindrical rivet section 22 having features providing security against rotation 20. In this embodiment, the bolt element furthermore has a shaft part 24 that is provided with a threaded cylinder 26. The shaft part 24 could, however, have different shapes; it can, for example, be a cylinder surface for a rotatable support of a component or a cylinder having one or more annular grooves for receiving a clip or a shaft part having a fir tree shape or a hook shape for receiving a carpet loop.

The shaft part 24 extends in an axial direction away from the flange 28 of the head part 16, while the rivet section 22 extends in the opposite axial direction away from the other side of the flange.

The features providing security against rotation 20 are formed by notches extending in parallel with the central longitudinal direction 12 at the outer jacket surface 30 of the cylindrical rivet section 22.

A security against rotation resistance is hereby achieved in accordance with the invention without further features providing security against rotation being provided that is at least 20% higher than with a corresponding SBF rivet element having conventional features providing security against rotation in the region of the sheet metal contact surface 14 of the flange 28.

The notches 20 here preferably extend over at least substantially the total length of the rivet section 22. They run out here in a rounded region 32 of the rivet section 22 at the free end of the rivet section 22 that represents a conventional rounded drawing edge. The notches 20 here have a shape that is rounded in cross-section and that corresponds to a semicircular cross-section, as can be seen in FIG. 1B.

It can be noted that the cylindrical rivet section 22 has a circular part-cylindrical surface in the regions between the notches 20. The rivet element can, as customary, be produced by a drop-forge process.

Due to the security against rotation values achievable in accordance with the invention, it is not necessary to provide further features providing security against rotation at the sheet metal contact surface 14, which simplifies the manufacture of the rivet element and ultimately also lowers the costs of the corresponding component assembly 70 (cf. e.g. FIGS. 4B to 4F).

As shown in FIGS. 2A to 2F, security against rotation recesses 34 can be provided at the sheet metal contact surface 14, in particular approximately having the shape of outwardly directed semicircular recesses that are arranged at angular positions around the central longitudinal axis 12 that respectively lie between two adjacent notches 20. Additional security against rotation can hereby be achieved.

There is furthermore the possibility, that is shown in FIGS. 3A to 3F, of providing security against rotation noses 36 at the sheet metal surface 12, in particular noses extending in the radial direction that are arranged at angular positions corresponding to the angular positions of the notches 20, i.e. are aligned therewith. The security against rotation resistance can hereby be further increased.

The attachment of the rivet bolt to a sheet metal part 40 is shown in FIGS. 4A to 4E, here with an additional security against rotation through the security against rotation recesses 34 and security against rotation noses 36 in accordance with FIGS. 3A to 3F. No reference numerals are used in FIG. 4C since this Figure represents FIG. 4B at a smaller scale and is only shown to demonstrate the sectional plane Y-Y, with the corresponding sectional drawing being shown in FIG. 4E. It can be recognized from this that the security against rotation nose 36 dents the sheet metal material (dent 42) and that a corresponding elevated portion in the sheet metal material fills the notch 20 disposed opposite the nose 36 at least locally. The sheet metal material is hereby deformed in a wave-like manner in the region of the noses, which also increases the security against rotation resistance, and indeed without thinning the sheet metal material to an non-permitted extent at points since the sheet metal material displaced by the noses can be received in the notches 20 that are disposed at the same angular positions as the noses 36.

In this example, a respective six notches 20, six recesses 34 and six noses 36 are provided. It is favorable if three to twelve notches 20 are provided; less than three notches 20 do not result in the desired security against rotation resistance and with more than twelve notches 20, they tend to have to be smaller, which can also have a disadvantageous effect on the security against rotation resistance. The number of recesses 34 (if provided) and of noses 36 (if provided) corresponds to the number of notches 20.

As can be seen from FIG. 4A, the sheet metal part 40 is provided with a crimp 46, that is pre-pierced in the center at 48, before the attachment of the rivet element. The crimp 46 and the pre-piercing 48 can be formed simultaneously in a manner known per se in a simple stamping step. The rivet element 10 is riveted into the sheet metal part 40 such that the flange of the head part 16 is arranged in the crimp. A U-shaped mount 52 in which the marginal region 54 of the pre-piercing 48 is clamped is produced between the upper side of the flange (as seen in FIG. 3A) and the rivet bead 50 due to the bead of the rivet section 22 to form the rivet bead 50. On the attachment of the rivet bolt 10, a setting head (not shown) is used that is well-known for the attachment of an SBF bolt element.

Instead of using the notches 20 in accordance with the invention with an SBF bolt element of the kind shown, they can also be used with an SBF bolt element with a conical sheet metal contact surface (not shown).

As can be seen from FIGS. 5A to 5F, the notches 20 in accordance with the invention can also be used with a modified NBR rivet bolt end 10. With an NBR bolt element 10, a skirt 56 is provided that serves as a rivet section 22 and the notches 20 are provided at the outer side of the skirt 56, i.e. at the cylindrical jacket surface of the rivet section 22. An annular groove 58 is located in the lower side of the flange 28 here.

A significant difference between the bolt element of FIGS. 5A to 5F and the previous SBF-like elements is that here the rivet section 22, i.e. the skirt 56, is arranged at the same side of the flange 28 as the shaft part 24, provided purely by way of example with a threaded cylinder 26 here, arranged concentrically to the rivet section. The annular groove 58 in the sheet metal contact surface here forms a part of the sheet metal contact surface and serves, as can be seen from FIGS. 9B, 9C, and 9E, to receive the rivet bead 50 such that the lower side of the rivet bead 50 does not project beyond the lower side 60 of the sheet metal part 40.

The embodiment of a modified NBR bolt element shown in FIGS. 6A to 6F has additional security against rotation noses 36 that have a bar shape and bridge the annular groove 58.

A further alternative of a modified NBR bolt element 10 can be seen in FIGS. 7A to 7F. Security against rotation recesses 34 are provided in the sheet metal contact surface 12 here analog to FIGS. 2A to 2F.

In the embodiment in accordance with FIGS. 8A to 8F, both the security against rotation noses 36 in accordance with FIGS. 6A to 6F and the security against rotation recesses 34 in accordance with FIGS. 7A to 7F are also provided in a modified NBR bolt element.

It can be seen from FIG. 9E that an elevated portion 44 of the sheet metal material that is located in a notch 20 of the rivet section or of the rivet bead 50 is here also located opposite an indentation 42 of the sheet metal material 40 caused by a security against rotation nose 36.

FIGS. 10A to 10F show, instead of a rivet bolt as previously described, a rivet nut in the form of a modified RSF rivet element. In a rivet nut, a central threaded bore 62 is typically provided in the head part 16. The head part 16 forms the sheet metal contact surface 14. In this embodiment, the notches 20 provided in accordance with the invention are provided as previously at the rivet section 22 that starts from the sheet metal contact surface 14. In a modification of a conventional RSN element, there are no features providing security against rotation at the sheet metal contact surface 12.

FIGS. 11A to 11F show a modified rivet element in the form of an RSN rivet element 10 that is very similar to the modified RSF rivet element of FIGS. 10A to 10F. In principle, only the rivet section 22 of the rivet element 10 is shorter than an RSF rivet element.

In a further embodiment of an RSF element in accordance with FIGS. 12A to 12F, security against rotation noses 36 are provided at the sheet metal surface 14 that are aligned angle-wise with the notches 20 at the rivet section 22.

In the embodiment in accordance with FIGS. 13A to 13F, both security against rotation recesses 34 and security against rotation noses 36 are provided at the sheet metal contact surface 14.

FIGS. 14A to 14F show a modified form of an RSN element similar to the embodiment of the RSF element in accordance with FIGS. 12A to 12F having security against rotation noses at the sheet metal contact surface 14. The security against rotation noses here have an approximately triangular shape in a side view.

FIGS. 15A to 15E show how the rivet element of FIGS. 12A to 12F is attached to a sheet metal part 40 having a pre-pierced crimp 46. The rivet element 10 is here inserted from above into the upwardly facing pre-piercing 48 of the sheet metal part 40 so that the rivet bead 50 can be accommodated within the likewise upwardly facing crimp and does not project beyond the lower side 60 of the sheet metal part 40 outside the crimp 46.

It can be noted that here the pre-piercing has been carried out such that a downwardly directed ring lip 64 arises in the marginal region 54 of the pre-piercing 48. The ring lip 64 and the marginal region 54 are here clamped in the U-shaped mount 52 between the sheet metal contact surface 54 and the rivet bead 50.

In the component assembly 70 that arises in this manner, an indentation 42 of the sheet metal part 40 caused by a security against rotation 36 is, as can be seen from FIG. 15E, disposed opposite an elevated portion 44 of the sheet metal material that is located in a notch 20 of the rivet section or of the rivet bead 50.

FIGS. 16A to 16E show the creation of a component assembly 70 that is produced by attaching the modified RSN element 10 of FIGS. 14A to 14F. FIGS. 16A to 16E largely correspond to FIGS. 15A to 15E, apart from the fact that the pre-pierced and pre-shaped sheet metal part 40 is not provided with a crimp, but is pre-shaped such that a conical arching arises. As can be seen from FIG. 16B, the conical position of the sheet metal part is partly pressed flat in accordance with the known blind rivet nut forming process, whereby a choke-hold of the sheet metal part 40 arises in the marginal region 54 of the pre-piercing 48 at the rivet section 22. The compressive strains arising in this manner protect the component assembly 70 from fatigue cracks and furthermore provide that the sheet metal material flows into the notches 20.

It can be seen from FIG. 16E that an indentation 42 of the sheet metal part caused by a security against rotation nose 36 is located opposite an elevated portion 44 of the sheet metal material that is located in a notch 20 of the rivet section or of the rivet bead 50.

FIGS. 17A to 17F show a further rivet nut, here in the form of an RND rivet element 10 modified in accordance with the invention. The corresponding element has, in a similar manner to the above-described RND rivet element, an annular groove 58 in the sheet metal contact surface 14 at the lower side of the flange 28. In this embodiment, the notches 20 in accordance with the invention are provided at the rivet section 22. The customary security against rotation bars of a conventional RND rivet element that bridge the annular groove 58 are not provided here, however, since excellent security against rotation values can be achieved solely by the notches 20.

If desired, however, higher security against rotation values can also be achieved if such security against rotation bars 36 are provided, as shown in the embodiment in accordance with FIGS. 18A to 18F.

RND elements are typically attached to a sheet metal part to form a component assembly 70 while using the blind rivet nut forming process mentioned in accordance with FIGS. 16A to 16E in a pre-pierced conical sheet metal position. The creation of the component assembly 70 for an RND rivet nut modified in accordance with the invention in accordance with FIGS. 18A to 18F is shown in FIGS. 19A to 19E.

It can be seen from FIG. 19E that an indentation 42 of the sheet metal part 40 caused by a security against rotation nose 36 is located opposite an elevated portion 44 of the sheet metal material that is located in a notch 20 of the rivet section or of the rivet bead 50.

FIGS. 20A to 20F show a further rivet nut, here in the form of an EMF rivet element 10 modified in accordance with the invention. In this embodiment, the notches 20 in accordance with the invention are provided at the rivet section 22; however, the customary security against rotation bars of a conventional EMF rivet element that bridge the annular groove 58 are not provided here since excellent security against rotation values can be achieved solely by the notches 20.

In an EMF element, the rivet section 22 is not formed as a hollow section, but is rather to be understood as a cylinder region 66 of increased diameter that merges via a ring shoulder 68 into the shaft part 24. On the attachment to a sheet metal part, a rivet bead 50 is peeled off or formed in an annular shape from the cylinder of larger diameter by means of a corresponding die button that engages at the ring shoulder 68, as can be seen from FIG. 24B, however, there for the similar EMF-like rivet element in accordance with FIGS. 23A to 23F.

FIGS. 21A to 21F show a further modified embodiment of an EMF rivet element 10. In this embodiment, the notches 20 in accordance with the invention are likewise provided at the rivet section 22; however, the customary security against rotation bars 36 of a conventional EMF rivet element that bridge the annular groove 58 are here likewise provided and provide even higher security against rotation values. The security against rotation bars 36 are here also aligned angle-wise with the notches 20.

In the embodiment in accordance with FIGS. 22A to 22F, instead of the security against rotation noses or security against rotation bars 36 of the embodiment in accordance with FIGS. 21A to 21F, elongate security against rotation recesses 34 extending in a radial direction are provided at the sheet metal contact surface 14. The security against rotation recesses 34 are also located at the inclined surface of the annular groove 58 and are arranged angle-wise respectively between two adjacent notches 20.

Finally, in the embodiment in accordance with FIGS. 23A to 23F, the security against rotation bars 34 of the embodiment in accordance with FIGS. 21A to 21F and the security against rotation recesses in accordance with FIGS. 22A to 22F are used simultaneously and result in even higher security against rotation values.

FIGS. 24A to 24E finally show how the rivet element 10 of FIGS. 23A to 23F is attached to a sheet metal part 40. The sheet metal part 40 is here also attached to a pre-pierced conical position 65 of the sheet metal part in accordance with the blind rivet nut forming process.

It can be seen from FIG. 24E that an elevated portion 44 of the sheet metal material that is located in a notch 20 of the rivet section or of the rivet bead 50 is here also located opposite an indentation 42 of the sheet metal material 40 caused by a security against rotation nose 36.

The functional element can comprise the same material that is normally used for half-hollow punch rivets or can comprise materials that are used for the production of screws of quality class 4.6 or 8.8 (or higher) according to DIN by means of cold working.

In all the embodiments, the movement of the sheet metal material into the notches 26 and 26′ or 26, 26′ takes place by cold working that arises when the sheet metal material is squeezed between the rivet element and the die button due to force application to the rivet element 10 or when the rivet section 22 of the rivet element is deformed by the die button.

### REFERENCE NUMERAL LIST

10 rivet element
12 central longitudinal direction of the rivet element 10
14 sheet metal contact surface of the rivet element 10
16 head part of the rivet element 10
20 notches at the rivet section 22
22 rivet section of the rivet element 10
24 shaft part of the rivet element 10
26 threaded cylinder
28 flange of the rivet element 10
30 outer jacket surface of the cylindrical rivet section 22
32 rounded region 32 at the free end of the rivet section 22
34 security against rotation recesses of the sheet metal contact surface
36 security against rotation noses or security against rotation bars at the sheet metal contact surface
40 sheet metal part
42 indentation of the sheet metal material in the region of a nose 36
44 elevated portion of the sheet metal material in the region of a notch 20
46 crimp 46 of the sheet metal part 40
48 pre-piercing 48 of the sheet metal part 40
50 rivet bead
52 U-shaped mount for the marginal region 54 of the pre-piercing 48
54 marginal region of the pre-piercing 48
56 skirt (corresponds to the rivet section 22)
58 annular groove in the sheet metal contact surface
60 lower side of the sheet metal part 40
62 threaded bore of the head part 16 of a rivet nut
64 ring lip of the conical sheet metal part position 65
64 conical sheet metal position
66 cylindrical region of larger diameter at the shaft part 24
68 ring shoulder
70 component assembly

1. A rivet element (10) having a central longitudinal direction (12), having a head part (16) that has a sheet metal contact surface (14) and having a cylindrical rivet section (22) that has features providing security against rotation,
characterized in that the features providing security against rotation are formed by notches (20) extending in parallel with the central longitudinal direction (12) at the outer jacket surface (30) of the cylindrical rivet section (22).

2. A rivet element in accordance with claim 1,
characterized in that the notches (20) extend over at least substantially the total length of the rivet section (22).

3. A rivet element in accordance with claim 1,
characterized in that the notches (20) have a shape that is rounded in cross-section and that in particular corresponds to a semicircular cross-section.

4. A rivet element in accordance with claim 3,
characterized in that the notches have a semicircular cross-section.

5. A rivet element in accordance with claim 1,
characterized in that the cylindrical rivet section (22) has a circular part-cylindrical surface (30) in the regions between the notches (20).

6. A rivet element in accordance with claim 1,
characterized in that no features providing security against rotation are provided at the sheet metal contact surface (14).

7. A rivet element in accordance with claim 1,
characterized in that recesses (34) providing security against rotation are provided at the sheet metal contact surface (14).

8. A rivet element in accordance with claim 7,
characterized in that the recesses (34) providing security against rotation have approximately the form of outwardly directed semicircular recesses that are arranged at angular positions about the central longitudinal axis that are respectively disposed between two adjacent notches (20).

9. A rivet element in accordance with claim 1,
characterized in that noses (36) providing security against rotation are provided at the sheet metal contact surface (14).

10. A rivet element in accordance with claim 9,
characterized in that the noses (34) extend in a radial direction and are arranged at, i.e. are aligned with, angular positions corresponding to the angular positions of the notches (20)

11. A rivet element in accordance with claim 1,
characterized in that from three to twelve notches (20) are provided.

12. A rivet element in accordance with claim 1,
characterized in that it is a bolt element.

13. A rivet element in accordance with claim 12,
characterized in that it is otherwise executed in the manner of one of an SBF element, an SBF element having a conical sheet metal contact surface and an NBR rivet bolt that can all be obtained from Profilverbindungstechnik GmbH & Co. KG.

14. A rivet element in accordance with claim 1,
characterized in that it is a nut element.

15. A rivet element in accordance with claim 13,
characterized in that it is otherwise executed in the manner of one of an RSF element, an RSN element, an RND element and f an EMF element that can all be obtained from Profilverbindungstechnik GmbH & Co. KG.

16. A component assembly (70) comprising a sheet metal part (40) to which at least one rivet element (10) in accordance with claim 1 is riveted,
characterized in that sheet metal material contacts the sheet metal contact surface (14) and is in engagement with the notches (20).

17. A component assembly in accordance with claim 16,
characterized in that recesses (34) providing security against rotation are provided at the sheet metal contact surface (14), and in that sheet metal material at the sheet metal contact surface (14) is in engagement with the recesses (34).

18. A component assembly in accordance with claim 16,
characterized in that noses (36) providing security against rotation are provided at the sheet metal contact surface (14) and in that sheet metal material at the sheet metal contact surface (14) is in engagement with the noses (36).

19. A component assembly in accordance with claim 17,
characterized in that noses (36) providing security against rotation are provided at the sheet metal contact surface (14) and alternate with said recesses (34) and in that sheet metal material at the sheet contact surface (14) extends in wave form over the noses (36) and into the recesses (34).

20. A component assembly in accordance with claim 18,
characterized in that sheet metal material at the sheet metal contact surface (14) is not incised or is only negligibly incised in the engagement region with the noses (36) since it is simultaneously in engagement with the notches (20).
